(19) United States
(12) Patent Application Publication
(10) Pub. No.: US 2009/0133518 A1
(43) Pub. Date: May 28, 2009

(54) MOTION CONVERTER

(75) Inventor: Hisashi KAWAMOTO, Chiba (JP)

Correspondence Address: KRATZ, QUINTOS & HANSON, LLP, 1420 K Street, N.W., Suite 400, WASHINGTON, DC, 20005, US

(73) Assignee: SEIKO PRECISION INC., Narashino-shi (JP)

(21) Appl. No.: 12/245,899

(22) Filed: Oct. 6, 2008

Related U.S. Application Data
(63) Continuation of application No. PCT/JP07/52239, filed on Feb. 8, 2007.

(30) Foreign Application Priority Data
Apr. 10, 2006 (JP) 2006-108126

(51) Int. Cl. F16H 25/12

(52) U.S. Cl. 74/89

(57) ABSTRACT

A motion converter includes a reduction gear mechanism and a stationary cylindrical portion. The reduction gear mechanism includes an input shaft, an external gear eccentrically rotatable about the input shaft, an internal gear internally meshing with the external gear and having a small number of difference between teeth of the internal gear and those of the external gear, and an disc for extracting only a rotational component of the external gear. The stationary cylindrical portion surrounds a periphery of the extracting member. Screw portions are respectively formed at an outer periphery of the extracting member and at an inner periphery of the stationary cylindrical portion, and screw together and support the disc for movement in a direction of the input shaft in response to an amount of rotation of the disc.

### CROSS-REFERENCE TO RELATED APPLICATIONS

This application is a continuation of and claims priority to International Patent Application No. PCT/JP2007/052239 filed on Feb. 8, 2007, which claims priority to Japanese Patent Application No. 2006-108126 filed on Apr. 10, 2006, subject matter of these patent documents is incorporated by reference herein in its entirety.

### BACKGROUND OF THE INVENTION

1. Field of the Invention

The present invention relates to a motion converter for converting rotary motion into linear motion.

2. Description of the Related Art

Conventionally, there has been known a reduction gear including an input shaft, an eccentric body rotated by the rotation of the input shaft, an external gear attached to the eccentric body and swung, an internal gear internally meshing with the external gear, and an output shaft coupled to the external gear through an extracting member for extracting only an rotational component of the external gear (see Japanese Patent No. 3034630).

Such a reduction gear enables the input shaft to be decelerated for rotating and transmit a rotary motion to the output shaft.

Additionally, in order to convert a rotary motion, outputted to such a reduction gear, and output as a linear motion in the axial direction of the input shaft, it is necessary to separately attach the above reduction gear to a mechanism for converting the rotary motion into the linear motion. By attaching the mechanism, for converting the rotary motion into the linear motion, to the above reduction gear, the rotary motion is decelerated to improve the positional accuracy in the direction of the input shaft. This also improves the positional accuracy, in the direction of the input shaft, of a member to which a motion in the direction of the input shaft is transmitted.

However, by attaching the mechanism, for converting the rotary motion into the linear motion, to the above reduction gear, the whole reduction gear is large-sized. Therefore, it is difficult to employ the mechanism in an electronic apparatus that should be downsized.

### SUMMARY OF THE INVENTION

It is therefore an object of the present invention to provide a motion converter which is downsized and which improves a positional accuracy of an extracting member.

According to an aspect of the present invention, there is provided a motion converter including a reduction gear mechanism and a stationary cylindrical portion. The reduction gear mechanism includes: an input shaft; an external gear eccentrically rotatable about the input shaft; an internal gear internally meshing with the external gear and having a small number of difference between teeth of the internal gear and those of the external gear, and an extracting member for extracting only a rotational component of the external gear. The stationary cylindrical portion surrounds a periphery of the extracting member. Screw portions are respectively formed at an outer periphery of the extracting member and at an inner periphery of the stationary cylindrical portion, and screw together and support the extracting member for movement in a direction of the input shaft in response to an amount of rotation of the extracting member.

With this structure, the whole motion converter can be downsized because the rotational motion of the extracting member is directly converted into the motion in the direction of the input shaft, as compared to where the reduction gear mechanism and a mechanism converting the rotational motion into the motion in the direction of the input shaft are separately provided. Further, the reduced rotational component is transmitted to the extracting member, thus slightly rotating the extracting member. This improves the positioning accuracy of the extracting member in the direction of the input shaft.

Additionally, the reduction gear mechanism includes: the input shaft; the external gear eccentrically rotatable about the input shaft; the internal gear internally meshing with the external gear and having a small number of difference between teeth of the internal gear and those of the external gear; and the extracting member for extracting only a rotational component of the external gear. Hence, the reduction ratio can be changed with ease by changing the number of teeth of the external gear or that of the internal gear. It is therefore made possible to control the amount of the rotation of the extracting member with accuracy by increasing the reduction ratio. This improves the positioning accuracy of the extracting member in the direction of the input shaft.

In the above structure, a pushing portion may be formed at a back side of a surface facing the external gear and pushes a pushed member.

This arrangement improves the positioning accuracy of the extracting member in the direction of the input shaft, thereby also improving the positioning accuracy of the pushed member by the extracting member.

As mentioned above, the reduction gear mechanism includes: the external gear eccentrically rotatable about the input shaft; the internal gear internally meshing with the external gear and having a small number of difference between teeth of the internal gear and those of the external gear; and the extracting member for extracting only a rotational component of the external gear. Therefore, high torque can be outputted to the extracting member, and the pushed member can be pushed with stability.

In the above structure, the stationary cylindrical portion and the internal gear may be integrally formed.

This structure reduces the number of parts and simplifies the assembling process.

In the above structure, the motion converter may include a positioning plate having a front face for positioning the reduction gear mechanism and a back face for positioning a motor transmitting a driving force to the input shaft, and the positioning plate and the internal gear may be integrally formed.

This structure reduces the number of parts and simplifies the assembling process.

In the above structure, the motion converter may include a rotor for rotating the input shaft; and an eccentric body for rotating the external gear eccentrically with respect to the input shaft, wherein the rotor and the eccentric body are integrally formed.

This structure prevents a play caused by assembling tolerance of the rotor and the eccentric body, thus improving the positional accuracy of the extracting member in the direction of the input shaft. Additionally, this reduces the number of parts and simplifies the assembling process.

In the above structure, the input shaft may penetrate through a hole formed in the extracting member, and guide a movement direction of the pushed member with the input shaft being slidably fitted into a guiding hole formed in the pushed member.

With this structure, the single input shaft is engaged with the eccentric body integrally formed with the rotor, and can guide the movement direction of the pushed member. Therefore, this reduces the number of parts and simplifies the assembling process.

In the above structure, the pushed member is a lens holder for holding a lens for movement in an optical axis direction.

This makes possible to improve the positioning accuracy of the lens in the optical axis direction.

### BRIEF DESCRIPTION OF THE DRAWINGS

FIG. 1 is a perspective view of a motion converter;

FIG. 2 is a cross-sectional view of the motion converter;

FIG. 3 is a view of a disc;

FIG. 4 is a view of an internal gear and an external gear;

FIG. 5 is a perspective view of the motion converter in which a disc is moved in a direction of an input shaft;

FIG. 6 is a view of a modification in accordance with the motion converter;

FIG. 7 is a front view of the motion converter employed in a lens driving apparatus for a camera;

FIG. 8 is a cross-sectional view of the motion converter employed in the lens driving apparatus for the camera;

FIG. 9 is a cross-sectional view of a motion converter, in accordance with a second embodiment of the present invention, employed in the lens driving apparatus for the camera; and

FIG. 10 is a front view of the motion converter, in accordance with a second embodiment of the present invention, employed in the lens driving apparatus for the camera.

### DESCRIPTION OF THE PREFERRED EMBODIMENTS

A description will now be given, with reference to the accompanying drawings, embodiments of the present invention.

### First Embodiment

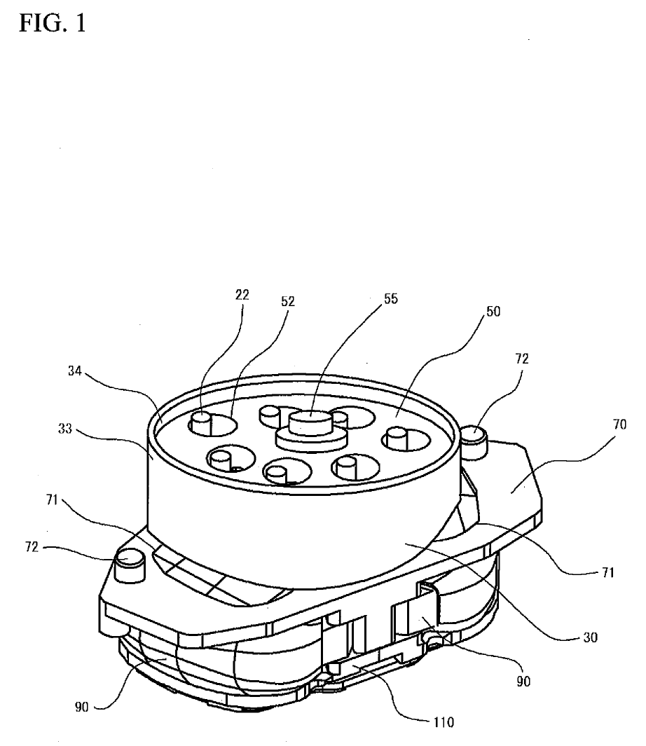

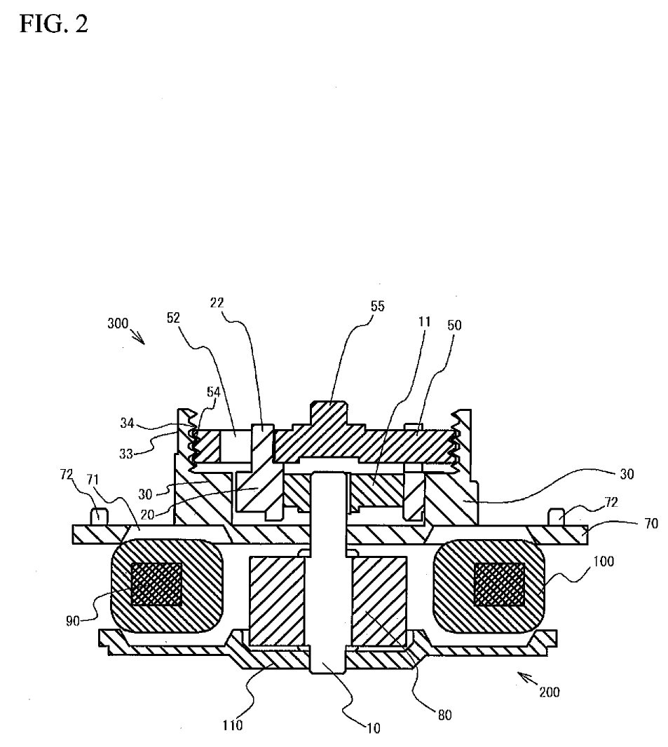

Referring to FIGS. 1 and 2, a motion converter according to an embodiment of the present invention will be explained. FIG. 1 is a perspective view of a motion converter 1. FIG. 2 is a sectional view of the motion converter 1.

As shown in FIGS. 1 and 2, the motion converter 1 includes: an input shaft 10; an eccentric body 11; an external gear 20 eccentrically rotatable about the input shaft 10; an internal gear 30 internally meshing with the external gear 20 and having a small number of teeth different from the external gear 20; a disc (extracting member) 50 for extracting only the rotation of the external gear 20; an upper cover 60; a positioning plate 70; a rotor 80; a stator 90, coils 100; and a motor cover 110.

Additionally, a motor 200 includes the input shaft 10, the rotor 80, the stator 90, the coils 100, and the motor cover 110. A reduction gear mechanism 300 includes the input shaft 10, the eccentric body 11, the external gear 20, the internal gear 30, and the disc 50.

The rotor 80 rotates by energization of the coils 100, and the input shaft 10 rotates in conjunction with the rotor 80. The input shaft 10 is supported in such a manner as to pass through a hole formed, for the input shaft 10, in the positioning plate 70. The input shaft 10 is connected to the external gear 20 at one end thereof through the eccentric body 11, and causes the external gear 20 to rotate in the rotational direction of the input shaft 10.

The external gear 20 is provided with external teeth 21, serving as trochoid-type curves, at an outer periphery thereof. The trochoid-type curve is traced by the solution of cycloid. The external teeth 21 are in mesh with internal teeth 31 of the internal gear 30. Moreover, the external teeth 21 of the external gear 20 are formed with pins 22 extending from a plain surface of the external gear 20 in a direction perpendicular to the plain surface of the external gear 20. The pins 22 are loosely fitted into pin holes 52 formed in the disc 50.

The eccentric body 11 is eccentric to the input shaft 10 and rotates integrally with the input shaft 10. Additionally, the eccentric body 11 is fitted into the external gear 20.

The internal gear 30 has the internal teeth 31 at an inner periphery of the internal gear 30. The internal teeth 31 are meshed with the external teeth 21 of the external gear 20. The internal gear 30 is integrally formed in the positioning plate 70. A stationary cylindrical portion 33 is formed in a partial periphery of the internal gear 30 so as to extend in the direction of the input shaft 10 and surround the disc 50.

An internal thread (screw portion) 34 is formed at an inner periphery of the stationary cylindrical portion 33.

Further, the stationary cylindrical portion 33, the internal gear 30, and the positioning plate 70 are integrally formed. This reduces the number of parts of the motion converter 1 and simplifies the assembling process thereof.

A external thread (screw portion) 54 is formed in an outer periphery of the disc 50. The external thread 54 screws the internal thread 34 formed in an inner periphery of the stationary cylindrical portion 33. The disc 50 has pin holes 52 into which the pins 22 loosely fitted. The internal thread 34, which is formed in the stationary cylindrical portion 33, and the external thread 54, which is formed in the outer periphery of the disc 50, serves as screw portions for supporting the disc 50 for movement in the direction of the input shaft 10 in response to the amount of the rotation of the disc 50. This will be described in more detail below.

The disc 50 has a pushing portion 55 for pushing a pushed member to be pushed. The pushing portion 55 is formed at a back face of a surface facing the external gear 20 to project in the direction of the input shaft 10.

The coils 100 are wound around the stator 90.

The motor cover 110 supports the input shaft 10 for rotation by being attached to the positioning plate 70, and holds the stator 90 wound with the coils 100.

As shown in FIG. 2, the positioning plate 70 is formed with the hole through which the input shaft 10 passes for supporting the input shaft 10. Therefore, the input shaft 10 is positioned by the positioning plate 70. Positioning guidable portions, not shown, are formed in the positioning plate 70 for positioning the stator 90 and the motor cover 110, the stator 90 being wound with the coils 100. This enables the motor 200 to be positioned.

As mentioned above, the positioning plate 70 is sandwiched between the reduction gear mechanism 300 and the motor 200 so as to position the reduction gear mechanism 300 at a front face of the positioning plate 70. Also, the positioning plate 70 positions the motor 200, which transmits the driving force to the input shaft 10, at the back face of the positioning plate 70. This enables a single member to position the reduction gear mechanism 300 and the motor 200. Accordingly, it is made possible to reduce the axial thickness of the motion converter 1 including the motor 200. Also, the single member enables the reduction gear mechanism 300 and the motor 200 to be positioned, thereby improving the assembling ability, and leading to the reduced manufacturing cost.

Furthermore, coil releasing holes 71 have the ability to release the thickness of the coils 100. This reduces the thickness in the axial direction of the motion converter 1. Also, the positioning plate 70 has guiding portions 72 for positioning the motion converter 1.

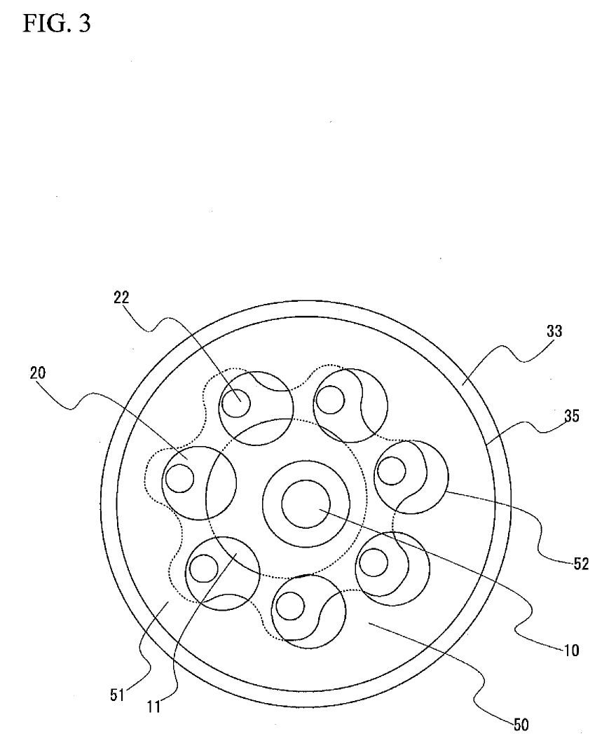

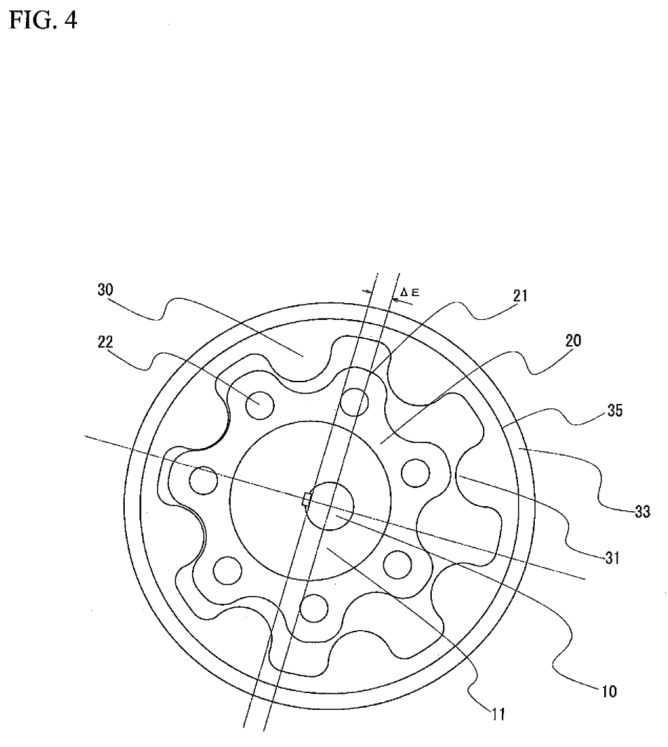

A description will be given of, with reference to FIGS. 3 and 4, the action of the motion converter 1. FIG. 3 is a view showing the output shaft 40 and the disc 50. FIG. 4 is a view showing the internal gear 30 and the external gear 20.

As shown in FIG. 3, the pins 22 are loosely fitted into the holes 52. The rotation of the input shaft 10 allows the eccentric body 11 press-fitted onto the input shaft 10 to be rotated, thereby rotating the external gear 20 fitted onto the eccentric body 11. Therefore, the rotation of the external gear 20 allows the rotational component of the external gear 20 to be transmitted to the disc 50 via the pins 22. Hence, the disc 50 rotates in response to the rotation of the external gear 20. The holes 52 absorbs orbital component of motion of the eternal gear 20 as will be described later.

In addition, as show in FIG. 4, the external gear 20 eccentrically rotates about the axis of the input shaft 10. The rotation of the eccentric body 11 allows the external gear 20 to be eccentrically rotated. The external gear 20 is meshed with the internal gear 30. This restricts the free rotation of the external gear 20, and the external gear 20 rotates with orbital component.

When the degree of the eccentricity is denoted by ΔE, the external gear 20 orbits along a circle with a radius corresponding to ΔE. As a result, the meshed position of the external gear 20 and the internal gear 30 is shifted in sequence, and one rotation of the input shaft 10 causes the external gear 20 to be out of phase with the internal gear 30 by a small number of difference between the teeth of the external gear 20 and those of the internal gear 30 (in this embodiment, eight minus seven equals one). This means that the above one rotation of the input shaft 10 results in the reduction in the speed to minus one-seventh. The one rotation of the input shaft 10 is reduced to being minus one seventh rotation of the external gear 20 (“minus” means reverse rotation).

As mentioned above, the only rotational component of the external gear 20 is outputted to the disc 50. This can achieve reduction ratio of minus one seventh between the input shaft 10 and the disc 50.

As mentioned above, in the reduction gear mechanism 300, the reduction ratio can be increased by increasing of the number of teeth of the external gear 20 and the internal gear 30. Additionally, the increasing of the reduction ratio allows high torque to be outputted to the disc 50.

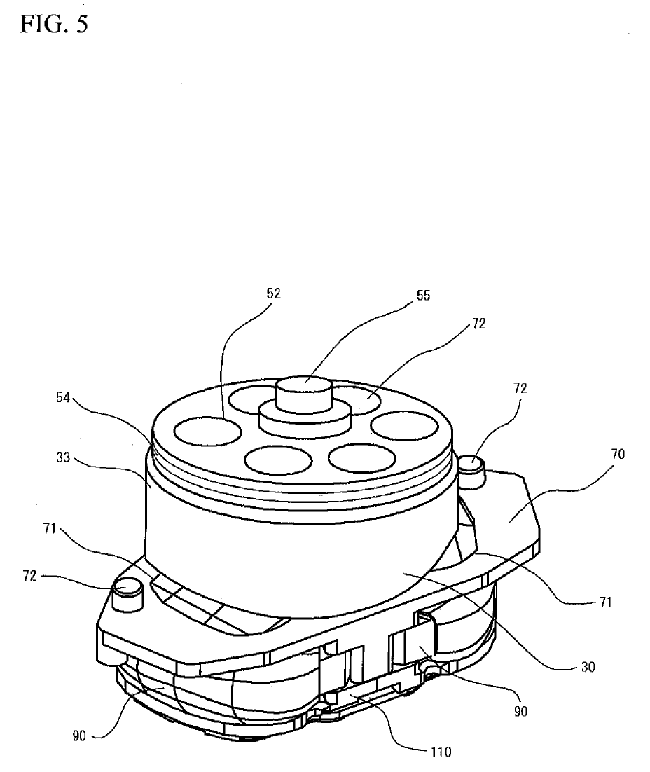

FIG. 5 is a perspective view of the motion converter in which the disc 50 is moved away from the motor 200 in a direction of the input shaft 10.

As mentioned above, the whole motion converter can be downsized because the rotational motion of the disc 50 is directly converted into the motion in the direction of the input shaft 10, as compared to where the reduction gear mechanism 300 and a mechanism converting the rotational motion into the motion in the direction of the input shaft 10 are separately provided. Specifically, it is possible to reduce the thickness in the direction of the input shaft 10.

Further, the reduced rotational component is transmitted to the disc 50, thus slightly rotating the disc 50. This improves the positioning accuracy of the disc 50 in the direction of the input shaft 10.

Additionally, the reduction gear mechanism 300 includes: the input shaft 10; the external gear 20 eccentrically revolves about the input shaft 10; the internal gear 30 internally meshed with the external gear 20 and having a small number of teeth different from the external gear 20; and the disc 50 for outputting only the rotation of the external gear 20. Hence, the reduction ratio can be changed with ease by changing the number of teeth of the external gear 20 or that of the internal gear 30. It is therefore made possible to control the amount of the rotation of the disc 50 with accuracy by increasing the reduction ratio. This improves the positioning accuracy of the disc 50 in the direction of the input shaft 10.

As mentioned above, in the disc 50, the pushing portion 55 is formed at a back face of the surface facing the external gear 20 and pushes the pushed member.

This arrangement improves the positioning accuracy of the disc 50 in the direction of the input shaft 10, thereby also improving the positioning accuracy of the pushed member pushed by the disc 50.

Additionally, as mentioned above, the change in the number of the teeth of the external gear 20 and that of teeth of the internal gear 30 enables the reduction ratio to become larger with ease. It is therefore made possible to control the amount of the rotation of the disc 50 with accuracy by increasing the reduction ratio. This improves the positional accuracy of the disc 50 in the direction of the input shaft 10.

Furthermore, it is made possible to change the amount of movement of the disc 50 in the direction of the input shaft 10 by changing the number of threads of the internal thread 34, which is formed at the inner periphery of the stationary cylindrical portion 33, and the number of threads of the external thread 54, which is formed at the outer periphery of the disc 50. The amount of movement of the disc 50 can be minutely set in accordance with the combination of the number of threads and the number of teeth of the external gear 20 and those of the internal gear 30 as mentioned above.

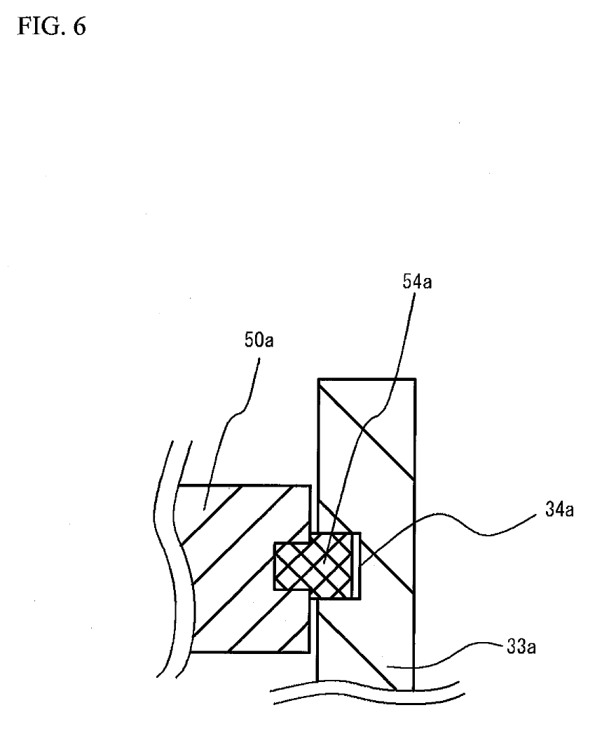

Moreover, in a modification of the motion converter 1, as show in FIG. 6, a cam channel 34a is formed at an inner periphery of the stationary cylindrical portion 33a, so that a cam follower 54a is provided to be slidably engaged into the cam channel 34a, whereby the amount of movement can be arbitrarily set.

Next, this motion converter 1 employed in a lens driving apparatus for a camera will be described.

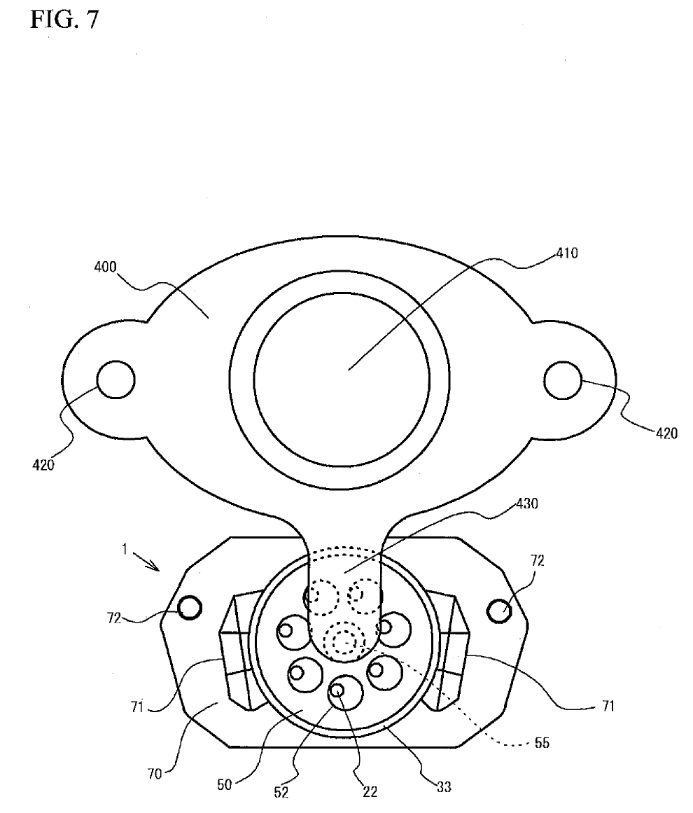

FIG. 7 is a front view of the motion converter 1 employed in a lens driving apparatus for a camera.

The motion converter 1 pushes a lens holder 400 serving as an pushed member. This lens holder 400 supports a lens 410 for movement in the optical axis direction (in a direction perpendicular to a plane of FIG. 7), the lens 410 guiding a light into an image pickup device as not shown. Additionally, the lens holder 400 has guiding holes 420 for guiding the movement of the lens holder 400 in the optical axis direction. The guiding holes 420 are slidably fitted onto guiding rods, not shown, respectively. Furthermore, the lens holder 400 has a pushed portion 430.

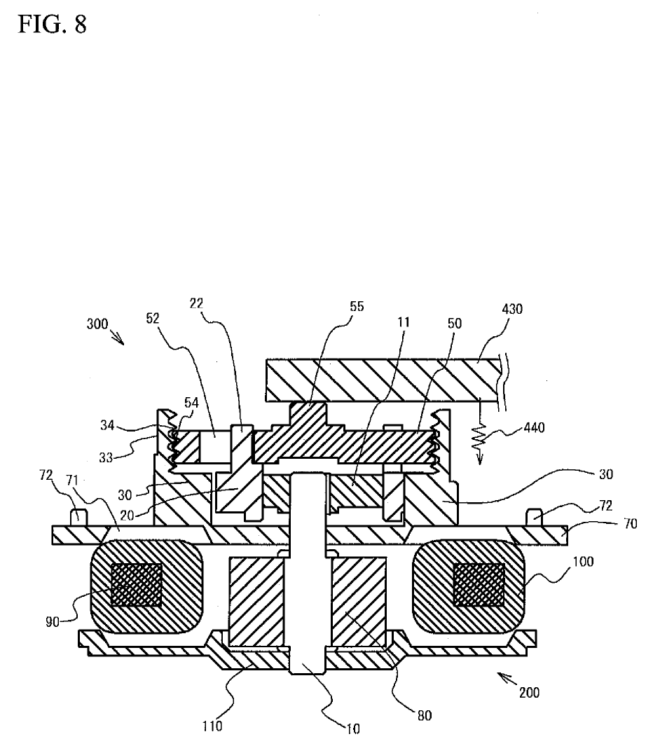

FIG. 8 is a cross-sectional view of the motion converter 1 employed in a lens driving apparatus for a camera.

The pushing portion 55 of the disc 50 is in contact with the pushed portion 430 of the lens holder 400. Furthermore, the pushing portion 55 is made of a material with a good slidability.

Moreover, the lens holder 400 is biased toward the motion converter 1 by an elastic member 440 such as a spring. Additionally, the elastic member 440 is simply illustrated in FIG. 8.

The disc 50 moves in the optical axis direction (in the direction of the input shaft 10) in response to the outputted rotation, thus moving the lens holder 400 in the optical axis direction. Specifically, when the disc 50 rotates and moves toward the object side (a front side of a drawing of FIG. 7), the pushing portion 55 pushes the pushed portion 430, thereby enabling the lens holder 400 to move toward the object side.

When the disc 50 rotates to move toward the input shaft 10, the lens holder 400 is biased toward the motion converter 1 by the elastic member 440, this enables the lens holder 400 to move toward an opposite side of the object side with the pushed portion 430 and the pushing portion 55 being in contact with each other.

As mentioned heretofore, the motion converter 1 is employed in the lens driving apparatus for camera, thus improving the positioning accuracy of the lens in the optical axis direction.

More specially, in a smaller sized camera, the downsizing is required for an apparatus which drives a lens. Therefore, the motion converter 1 according to the present invention is suitable for such a downsized camera.

### Second Embodiment

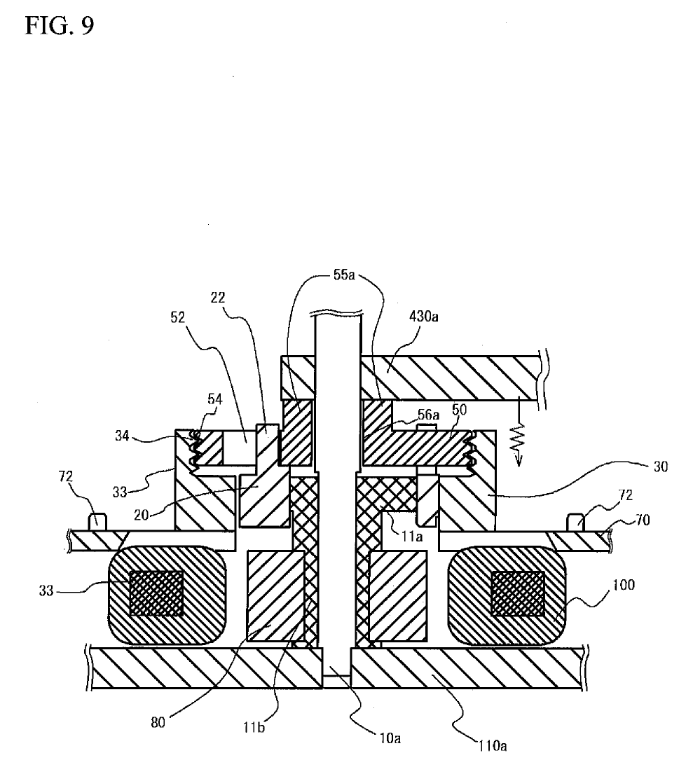

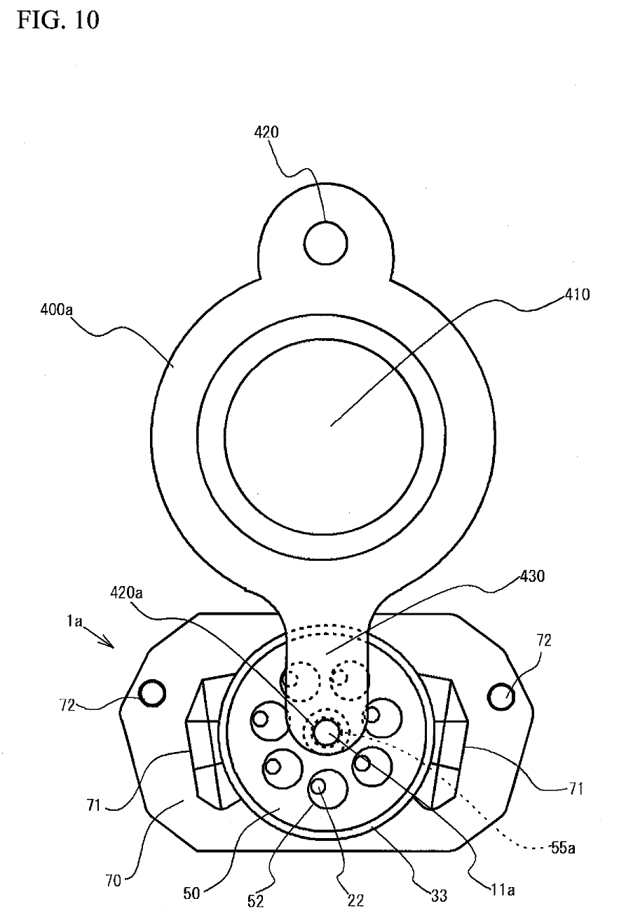

A motion converter according to a second embodiment of the present invention will be described. Additionally, elements which are similar to the motion converter 1 according to the first embodiment are given the same designations, and repetitive descriptions are omitted. FIG. 9 is a cross-sectional view of a motion converter 1a, according to the second embodiment of the present invention, employed in a lens driving apparatus for a camera. FIG. 10 is a front view of the motion converter 1a, according to the second embodiment of the present invention, employed in the lens driving apparatus for the camera.

As shown in FIG. 9, an eccentric body 11a, a bearing portion 11b, and the rotor 80 are integrally formed by insert molding. This prevents a play caused by assembling tolerance of the eccentric body 11a, the bearing portion 11b and the rotor 80, whereby the eccentric body 11a allows the external gear 20 to smoothly swing and rotate.

Additionally, an input shaft 10a is slidably fitted into the eccentric body 11a integrally formed with the rotor 80. The input shaft 10a extends to penetrate through a through hole 56a. Further, the input shaft 10a is made of a material with good slidability.

Furthermore, motor cover 110a has a thickness greater than that of the motor cover 110 according to the first embodiment so as to securely hold the input shaft 10a which guides the movement direction of the lens holder 400a to be mentioned below.

The motion converter 1a pushes the lens holder 400a serving as pushed member. The lens holder 400a holds the lens 410 for movement in the optical axis direction, the lens 410 guiding a light to an image pickup device (not shown). Additionally, the lens holder 400a has guiding holes 420, 420a for guiding the lens holder 400a in the optical axis direction. A guiding rod (not shown) is slidably fitted into the guiding hole 420. Furthermore, the input shaft 10a of the motion converter 1a is slidably fitted into the guiding hole 420a.

In addition, a pushing portion 55a is formed around the through hole 56a.

As mentioned heretofore, the input shaft 10a penetrates through the through hole 56a formed in the disc 50, and is slidably fitted into the guiding hole 420a formed in the lens holder 400a to guide the movement direction of the lens holder 400a. Therefore, the single input shaft 10a is slidably engaged with the eccentric body 11a integrally formed with the rotor 80, and guides the movement direction of the lens holder 400a. This reduces the number of parts and simplifies the assembling process.

Additionally, since the motor cover 110a is formed thicker, the extending input shaft 10a may be rotatebly supported with stability. Moreover, a chassis mounted in the motion converter 1, instead of the motor cover 110a, may support the input shaft 10a for rotation.

While the preferred embodiments of the present invention have been illustrated in detail, the present invention is not limited to the above-mentioned embodiments, and other embodiments, variations and modifications may be made without departing from the scope of the present invention.

Although the input shaft is also served as a motor shaft in the above embodiments, the present invention is not limited to the above configuration.

Additionally, although the internal gear 30 and the positioning plate 70 are integrally formed in the above embodiments, the present invention is not limited to the above configuration, the internal gear and the positioning plate may be separately formed.

Further, although the lens holder serving as the pushed member is explained in the above embodiment, the present invention is not limited to the above configuration.

Moreover, although the rotor and the eccentric body are integrally formed with each other in the above embodiment, the input shaft, the rotor, and the eccentric body may be integrally formed with one another.

What is claimed is:

1. A motion converter comprising:
a reduction gear mechanism including an input shaft, an external gear eccentrically rotatable about the input shaft, an internal gear internally meshing with the external gear and having a small number of difference between teeth of the internal gear and those of the external gear, and an extracting member for extracting only a rotational component of the external gear; and
a stationary cylindrical portion for surrounding a periphery of the extracting member,
wherein screw portions are respectively formed at an outer periphery of the extracting member and at an inner periphery of the stationary cylindrical portion, and screw together and support the extracting member for movement in a direction of the input shaft in response to an amount of rotation of the extracting member.

2. The motion converter according to claim 1, wherein the extracting member has a pushing portion that is formed at a back side of a surface facing the external gear and pushes a pushed member.

3. The motion converter according to claim 1, wherein the stationary cylindrical portion and the internal gear are integrally formed.

4. The motion converter according to claim 1, comprising a positioning plate having a front face for positioning the reduction gear mechanism and a back face for positioning a motor transmitting a driving force to the input shaft,
wherein the positioning plate and the internal gear are integrally formed.

5. The motion converter according to claim 1, comprising:
a rotor for rotating the input shaft; and
an eccentric body for rotating the external gear eccentrically with respect to the input shaft,
wherein the rotor and the eccentric body are integrally formed.

6. The motion converter according to claim 1, wherein the input shaft penetrates through a hole formed in the extracting member, and guides a movement direction of the pushed member with the input shaft being slidably fitted into a guiding hole formed in the pushed member.

7. The motion converter according to claim 1, wherein the pushed member is a lens holder for holding a lens for movement in an optical axis direction.
